(19) United States
(12) Patent Application Publication
(10) Pub. No.: US 2008/0260883 A1
(43) Pub. Date: Oct. 23, 2008

(54) Plant for Producing Slabs of Conglomerate Stone Material

(76) Inventor: Dario Toncelli, Bassano del Grappa (Vicenza) (IT)

Correspondence Address: KATTEN MUCHIN ROSENMAN LLP, 575 MADISON AVENUE, NEW YORK, NY, 10022-2585, US

(21) Appl. No.: 12/067,715

(22) PCT Filed: Oct. 6, 2006
(86) PCT No.: PCT/EP06/67152

§ 371 Date: Mar. 21, 2008

(30) Foreign Application Priority Data
Oct. 14, 2005 (IT) TV2005A000155

(51) Int. Cl. B28B 5/04

(52) U.S. Cl. 425/88

(57) ABSTRACT

In a plant for manufacturing conglomerate sheets comprising a first station (24) for filling moulds (22) with mix formed by a stone material and a binder, a second vacuum vibrocompression station and a third station for hardening of the rough-formed sheet, a carriage (38) provided with gripping means (40, 41), in particular gripper jaw means, is mounted on a fixed supporting and sliding surface (36) situated downstream of the second station and coplanar with the base (30) of the vibrocompression machine (32). The carriage (38) is movable between a position where it inserts each mould into the second station and, after vibrocompression, prepares it for subsequent transfer to the hardening station.

The present invention relates to the production of articles of conglomerate stone material, in particular in the form of slabs, and more specifically to a plant for said production process.

In relatively recent years technology for the manufacture of articles, consisting of a conglomerate stone or stone-like material, has been developed and has become established industrially, these articles being characterized by various advantageous properties, the main one of which is the possibility of producing large size blocks (about 3.20×1.60 metres) with a relatively small thickness (a few centimetres), such that they are suitable for forming internal and external cladding and flooring of buildings as well as furnishing components.

Secondly these articles have a notable uniformity in terms of external appearance, in particular of the surface which is intended to remain visible, these properties being difficult to obtain in the case of slabs obtained by means of sawing from blocks of natural stone (such as marble, granite, porphyry, etc.).

Thirdly these conglomerate articles may be made from surplus crushed stone material, namely material which would otherwise remain unused after extraction of blocks of stone material from the quarries, with an obvious advantage not only from the point of view of cost of the raw materials but also as regards environmental impact.

The technology in question, which is commercially known as “Bretonstone™” envisages essentially:

(a) preparation of an initial mix consisting mainly of one or more stone or stone-like granular materials, said granular materials having a selected particle size, a filler and a binder;

(b) deposition of a layer of this mix, with a predefined thickness, on a temporary support surface and subsequent covering of the mix with a similar support;

(c) a vacuum vibrocompression step, during which the mix undergoes the action of a press in an environment in which a predefined vacuum has been formed and at the same time a vibratory movement of predefined frequency is applied to the layer;

(d) a final step involving hardening of the resultant rough-formed article, the procedures for this step depending mainly on the nature of the binder.

In the technology in question it is possible to use an inorganic binder, in particular of the cement-based type, in which case the hardening step is performed using the procedures which are typical of cement-based articles.

Alternatively, it is possible to use a binder consisting of an organic hardening resin, in which case hardening of the rough-formed slab is performed using techniques which are well-known for synthetic resins, usually by means of the combined action of a catalyst agent and an accelerator with application of heat, where necessary.

For more detailed information regarding these processes and plants for producing articles in the form of slabs reference should be made to the following patents: EP-A-0,786,325 and 1,027,205 relating to the use of organic binders, WO-A-2004/039547 relating to inorganic binders, and IT-A-1,181,570 relating to preparation of the initial mix.

The plant for producing slabs using the technology briefly mentioned above envisages substantially an upstream section in which the starting mix is prepared, a first station in which the mix is deposited on a temporary support so as to then be covered with a protection similar to said support, a second station in which the mix is subjected to vacuum vibrocompaction and, finally, a third station in which hardening of the slab is performed.

In the plants known hitherto and constructed the starting mix is preferably deposited in a mould of elastomer material resting on a conveyor belt and subsequently covered by a protective sheet made of material similar to that of the mould.

Feeding of the conveyor belt brings the layer of mix deposited in the mould and lined with the protective sheet into the vacuum vibrocompression station. In this station a machine comprising a vibrating ram or pressing plate operates, said ram or plate being made to perform a vertical movement and being enclosed in an environment in which a vacuum of predefined value is formed. At the same time, during compression, a vibratory movement with a predefined frequency is applied to the layer of mix.

In all these types of plant the conveyor belt, which is normally made of a fabric-like elastomer material and comprises an upper section or operating section and a bottom section or return section, is subject—specifically in the region of the vacuum vibrocompression station—to various problems which hitherto have not been solved in an industrially satisfactory manner.

In fact, in the region of the vibrocompression station, the plant has a solid foundation able to withstand the high stresses which are exerted by the pressing plate. The foundation has a raised surface on which the metal base of the vibrocompression machine is secured and where, along the surface, the upper section of the conveyor belt moves towards the bottom section, coming into contact therewith. The conveyor belt, which stops temporarily during operation of the vacuum vibrocompression machine, during other stages of the operating cycle is fed forwards intermittently. During feeding, precisely on the metal base of the aforementioned machine, the two sections of the conveyor belt travel in mutual contact and the nature of the material from which the conveyor belt is made prevents easy sliding.

Moreover, precisely when the belt stops during operation of the vibrocompression machine, the two sections of the belt must adhere perfectly to each other, in order to prevent unevenness or depressions which may result in incorrect compression of the layer of mix and therefore in defects in the final slab.

The perfect adhesion between the two sections of the belt in turn results in a further difficulty when the conveyor belt starts to move again after being stopped.

On the aforementioned metal base of the machine the bottom section of the belt may adhere to the abovementioned raised surface with a suction effect, so that the belt is prevented from moving again once the vibrocompression step has been completed.

Unless special measures are adopted, the bottom section of the conveyor belt accumulates on the raised surface residual amounts of encrusted mix which must be removed so as not to prevent correct operation of the vibrocompression machine, therefore resulting in the need for frequent cleaning and therefore a greater downtime or inactivity of the plant.

In the region of the aforementioned base, the pressing plate is enclosed inside a bell-shaped cover which ensures that vibrocompression is performed under a vacuum. This bell-shaped cover is movable vertically and its bottom edges must provide a sealing effect by means of a seal acting on the upper section of the conveyor belt.

However, in the region of the aforementioned raised surface, the seal is provided on a double layer consisting of both the sections of the conveyor belt. Thus, especially when the surrounding temperature is low (as during the winter period) so that the seal hardens, the air sealing effect is limited, to the detriment, therefore, of the degree of vacuum which can be achieved in the aforementioned bell cover.

Finally, intermittent feeding of the conveyor belt must ensure that the mix to be compacted is perfectly positioned underneath the pressing plate. Since the conveyor belt has a considerable extension lengthwise, not infrequently it happens that, for example owing to thermal expansion and/or mechanical stressing, the length varies to a such degree as to upset correct positioning of the layer of mix with respect to the plate of the vibrocompression machine.

The main object of the present invention is therefore to solve in an industrially advantageous manner the problems and the drawbacks briefly described above.

This object is achieved with the plant according to the present invention of the type comprising, in addition to an upstream section where the initial mix is prepared:
a first station for depositing the mix in the form of a layer with a uniform and predetermined thickness inside a tray mould having surrounding edges with a height slightly smaller than the final thickness of the compacted slab, the mould being able to be covered after deposition of the mix with a protective sheet;
a second station in which a vacuum vibrocompression machine comprising a vibrating ram or pressing plate operates, and
a third station for hardening the binder of the initial mix so as to form a slab of conglomerate,

characterized in that it comprises transfer means able to insert, by means of conveying, each tray into said second station in a position aligned with said vibrating ram, said transfer means being operative so as to extract, by means of conveying, said tray mould from said second station, after the vacuum vibrocompression step.

In the preferred embodiment of the present invention said transfer means consist of gripping means which, in a further preferred embodiment, are gripper jaw means.

As may be better appreciated from the detailed description which follows of a preferred, but not exclusive embodiment of the invention, said description being provided in relation to the accompanying drawings, all the problems and drawbacks of the prior art solution are solved in an industrially advantageous manner.

In the drawings:

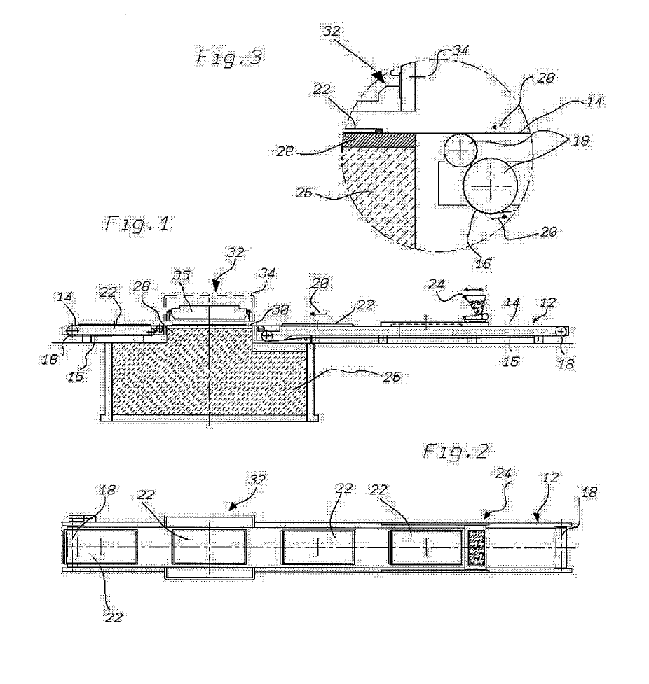

FIGS. 1 and 2 are schematic views, i.e. a side elevation and top plan view, respectively, of the plant according to the prior art described above;

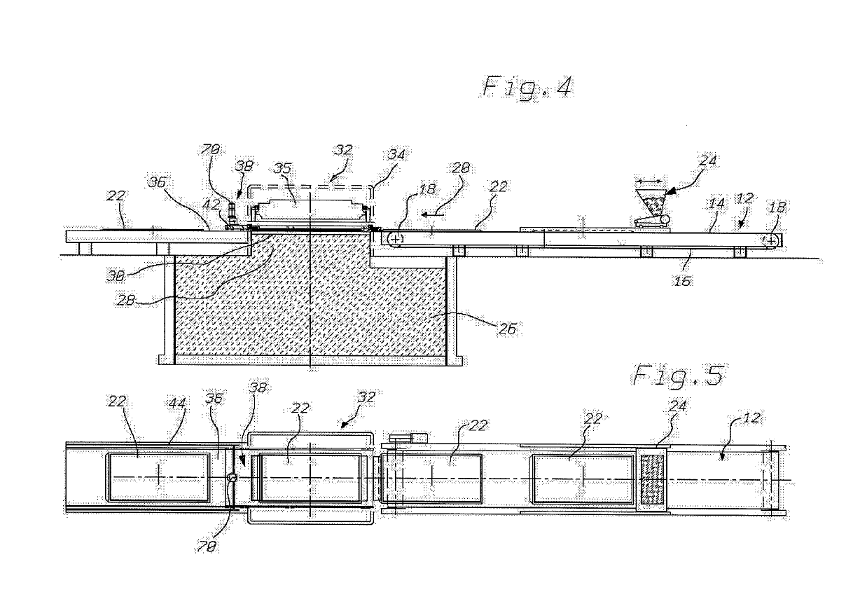

FIG. 3 is an enlarged view of the detail of this plant, shown encircled by a dot-dash circle in FIG. 1;

FIGS. 4 and 5 are views, similar to those of FIGS. 1 and 2, of the plant according to the present invention;

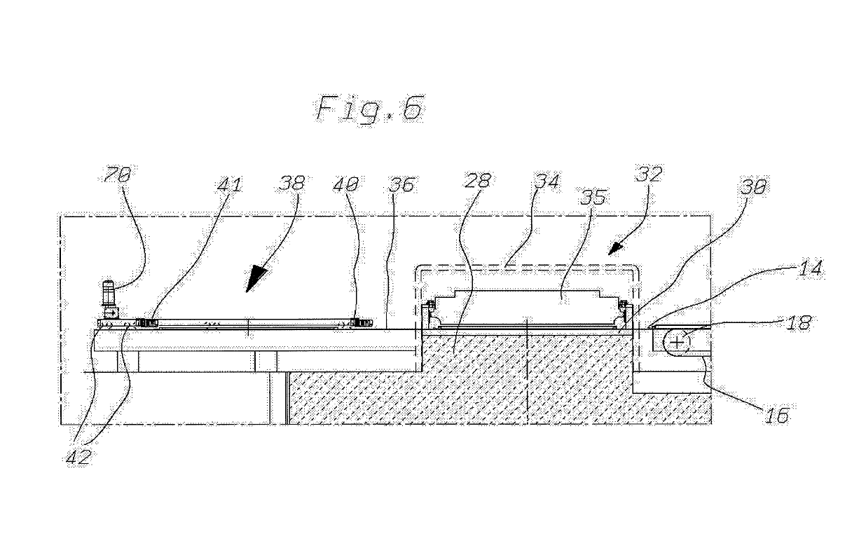

FIG. 6 is a partial view, similar to FIG. 4, of the plant with the layer of mix positioned inside the vibrocompression station.

FIGS. 7-10 are enlarged detail views which show different operating conditions of the means for transferring the moulds of the plant according to the invention.

With reference first of all to FIGS. 1 to 3, the plant according to the prior art comprises an endless conveyor belt 12 consisting of an upper or operating section 14 and a bottom or return section 16. Suitable drive and transmission rollers 18 cause feeding of the belt 12 in the direction indicated by the arrows 20.

Moulds 22, preferably of the type described in the patent EP-A-1,027,205, are deposited on the upper section 14 of the conveyor belt 12 so that each mould is firstly arranged in the filling station where a dispensing machine (of the type described, for example, in the abovementioned patent application WO-A-2004/039547), indicated generically by the reference number 24, performs filling of the mould with a layer of mix of the desired thickness.

Once this phase has been completed, after covering the layer of mix with a protective sheet, the mould is fed to the vibrocompression station which comprises a solid foundation 26 forming a raised surface 28 which supports the metal base 30 of the vibrocompression machine indicated generally and overall by the reference number 32.

As already mentioned, the vibrating ram or pressing plate 35 of the machine 32 is movable vertically between a raised or inactive position (visible in FIG. 1) and a lowered or operating position and is enclosed inside an outer bell cover 34 which is also movable vertically and inside which a predetermined degree of vacuum may be established.

From FIG. 3 it can be readily appreciated that the bottom section 16 of the conveyor belt 12, in the region of the raised surface 28, is deviated by the transmission rollers 18, so as to pass over the metal base 30. Consequently, the bottom section 16 comes into contact with the upper section 14 of the conveyor belt 12.

The intermittent feeding movement of the conveyor belt 12 brings each mould opposite and into alignment with the pressing plate 35, following which feeding of the conveyor belt 12 is interrupted and the vacuum bell cover 34 is lowered until it presses against the upper surface of the belt 12, with a pressure such as to ensure a seal against the external air and therefore allow the formation of a fairly pronounced vacuum inside the bell cover.

At this point (namely after the vacuum has been created inside the bell cover) the ram 35 performs the downward stroke, engaging with the upper surface of the mould 22 and pressing the layer of mix contained inside it.

At the same time, as already mentioned, a vibratory movement of predetermined frequency is applied to the ram 35 resting on the mould and pressing continues until the desired result has been achieved, i.e. in particular that of compacting the layer of mix with a settled arrangement of the granular materials which form it.

Once this step has been completed, feeding of the conveyor belt 12 is resumed and the mould 22, as a result of this feeding movement, is extracted from the vibrocompression station so as to be removed and transferred to the following station of the plant where the mix undergoes hardening, using procedures determined by the nature of the binder with which it was prepared.

If we now consider the plant according to the present invention, the general structure of which is shown in FIGS. 4 to 6 (relating to a preferred embodiment and using the same reference numbers for components which are substantially identical to those of FIGS. 1 to 3), it again comprises a conveyor 12, preferably of the belt type, which conveys the moulds 22, which are of the same type as that described above and are filled with the mix distributed in a uniform layer, as far as the front end of the vibrocompression machine.

The latter has substantially the same configuration as that shown in FIGS. 1 to 3 and comprises a foundation 26 with a raised surface 28 which supports the metal base 30, the vibrating ram or pressing plate 35 able to perform a vertical translatory movement between a raised or inactive position and lowered or working position.

A vacuum bell(-shaped) cover 34 encloses the vibrocompression machine and is also able to perform a vertical displacement between a raised or inactive position and a lowered or working position, where it forms a hermetic seal with its bottom edge (preferably via a sealing element) against the base 30, surrounding and enclosing both the vibrating ram 35 and the mould 22 positioned opposite and below it.

Downstream of the vibrocompression station there is envisaged a supporting and sliding surface 36 aligned horizontally both with the upper surface of the metal base 30 and with the travel surface 14 of the conveyor 12. In particular the upper side of the surface 36 forms together with the upper surface of the base 30 a single sliding plane.

The upper side of the support surface has, slidably mounted thereon, a carriage—denoted overall by the reference number 38—which is mounted on wheels 42 and provided with an on-board drive unit 70 which controls the displacement thereof along travel or guide ways 44 parallel to each other and parallel to the edges of the surface 36 (see FIGS. 5 and 6).

In this preferred embodiment, the front and the rear of the carriage 38 are provided with gripper jaw means 40 and 41 which are identical to each other and which will now be described with particular reference to FIGS. 7 to 10 which show the front gripper jaws 40. The gripper jaws 40, which are directed towards the vibrocompression machine, have the function of gripping the mould 22 with the soft mix to be introduced into the machine, while the rear gripper jaws 41 have the function of simultaneously gripping the mould with the compacted mix to be extracted from the machine. In this way, with a single displacement of the carriage 38, two moulds are moved simultaneously, saving precious time and compressing the production cycle of the plant.

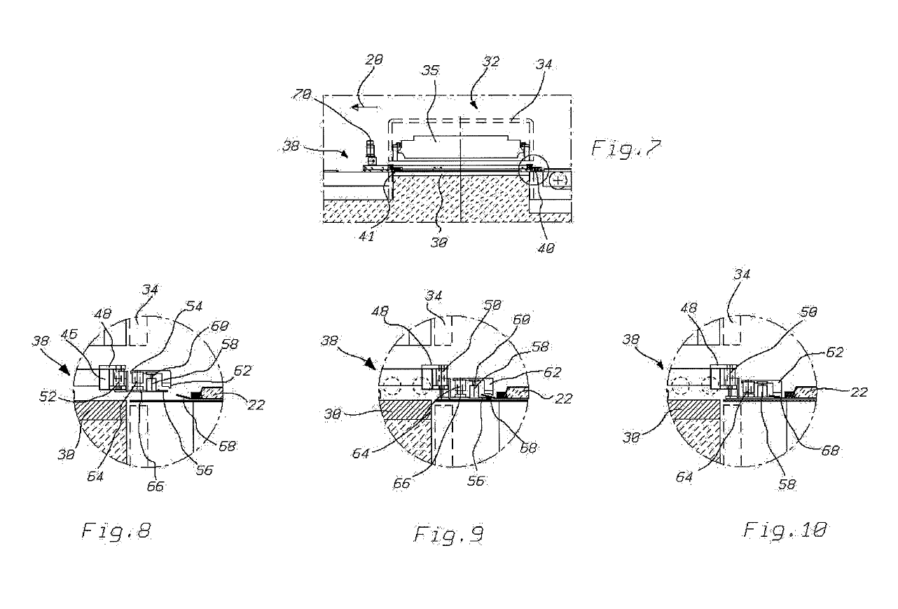

The carriage 38 consists of a quadrangular frame with two longitudinal members on which the wheels 42 are mounted and two cross-pieces carrying the gripper jaw means 40, 41. A C-shaped flange, denoted by the reference number 48, is integral with the front cross-piece 46 (shown in FIGS. 8 to 10). The arms of the flange 48 projecting from the front of the cross-piece 46 are connected by a vertical cylinder 50 of a first cylinder and piston assembly having the function of raising and lowering the gripper jaws 40, since it must remain raised during the fast entry of the carriage 38 into the vibrocompression machine in order to pass above the mould containing the compacted slab to be extracted. The piston 52 of the cylinder 50 is integral with the end of a bracket 54 which has substantially the form of an L, the bottom side 56 of which forms the first of the two gripping members of the gripper jaws 40. Said side 56 has, mounted thereon, a second cylinder and piston assembly, the cylinder 58 of which is rigidly fixed to the side 56, while the piston 60 is integral with the second gripping member 62 of the gripper jaws 40.

Said gripping member 62 is guided during the vertical raising and lowering movement, produced by displacement of the piston 60 with respect to the cylinder 58, by a bush 64 which is keyed onto a pin 66 which is also rigidly fixed to the bottom side 56 of the bracket 54.

Both the first gripping member 56 of the gripper jaws 40 (which, as already mentioned, is formed by the bottom side 56 of the bracket 54) and the second member 62 extend parallel to the cross-piece 46, namely transversely with respect to the direction of feeding of the moulds 22, over a distance substantially equal to the width of the said moulds.

The carriage 38 is movable between a first position—shown in FIG. 6—where it is totally retracted on the supporting and sliding surface 36 where it deposits the mould with the compacted slab extracted from the vibrocompression machine, and a second position—shown in FIG. 7. In this second position, the carriage 38 is arranged over most of the base 30 of the press, with the front gripper jaws 40 projecting from the upstream side of the vibrocompression machine for gripping a mould containing the mix distributed in a thin layer to be compacted and with the rear gripper jaws 41 positioned for simultaneous gripping of the mould containing the compacted slab inside the machine.

From FIGS. 8, 9 and 10 it can be appreciated how the mould 22 has a lip 68 projecting in an inclined manner upwards from the base of the mould 22, in a position suitable for being gripped by the gripper jaw means 40.

When it is required to perform transfer of a mould inside the vibrocompression machine, with the pressing plate 32 and the vacuum bell cover 34 raised, the carriage 38 is arranged in the condition shown in FIG. 8, where the piston 52 is retracted inside the cylinder 50 and therefore the bracket 54 with its side 56 is raised with respect to the sliding surface of the carriage 38.

The piston 52 of the cylinder 50 then lowers the first gripping member of the gripper jaws 40, namely the side 56 of the bracket 54, until it is substantially aligned horizontally with the plane of the base 30 and its front edge is positioned underneath the lip 68 of the mould 22—see FIG. 9.

In this condition the carriage 38 performs displacement from the position shown in FIG. 6 into that shown in FIG. 7.

The cylinder 58 is then actuated so as to cause retraction of the piston 60, so that the second gripping member 62 of the gripper jaws 40 moves towards the free edge of the side 56 of the bracket 54, trapping the lip 68 of the mould which in this way is firmly gripped—see FIG. 10.

By suitably actuating the motor 70, the carriage 38 is displaced in the direction of the arrow 20, conveying with it two moulds 22 until one is positioned exactly on the base 30 of the vibrocompression machine.

The front gripper jaws 40 are then disengaged from the lip 68 of the mould containing the soft mix to be compacted with an operating sequence of the cylinder and piston assemblies 50, 52 and 58, 60, opposite to that of the abovementioned movement (see FIG. 8), following which the carriage 38 is displaced into the position of FIG. 6 for disengagement of the rear gripper jaws 41 from the lip 68 of the mould containing the compacted mix (with a similar operating sequence of the cylinder and piston assemblies), which mould will then be transferred via other means to the hardening station.

It is now possible to perform the vibrocompression step, at the end of which, by means of a similar procedure, the carriage 38 is able to perform extraction of the mould 22 from the vibrocompression machine by means of the rear gripper jaws 41 and its transfer by means of conveying on the support surface 36, from where it will be then transferred to the next station in order to undergo hardening.

From the above description it is clear that with the present invention the problems and drawbacks of the prior art are fully solved in an industrially advantageous manner.

It is also clear that, within the scope of the following claims, modifications and variants which are conceptually and/or mechanically equivalent are possible and may be envisaged, especially as regards the gripping means for gripping and conveying the moulds into the successive positions and stations.

For example, the gripper jaw means could consist of hook members able to extend and retract so as to engage with shaped projections formed on the outer walls of the moulds.

It is therefore understood that the scope of the present invention also includes any transfer means which are able to remove each tray and position it at least in said second station, namely in the vibrocompression machine, and preferably also in a successive deposited position from where it may then be transferred to the station where hardening of the mix takes place.

1. Plant for manufacturing conglomerate articles in the form of slabs of stone material of the type comprising, in addition to an upstream section where the initial mix is prepared:
a first station (24) for depositing the mix in the form of a layer with a uniform and predetermined thickness inside a tray mould (22), the mould being able to be covered after deposition of the mix with a protective sheet;
a second station in which a vacuum vibrocompression machine comprising a vibrating ram or pressing plate (35) operates, and
a third station for hardening the binder of the initial mix so as to form a slab of conglomerate,
characterized in that it comprises transfer means (38, 40, 41) able to insert, by means of conveying, each tray mould (22) into said second station, said transfer means being operative so as to extract, by means of conveying, after the vacuum vibrocompression step, said tray mould (22) from said second station so as to prepare it for subsequent transfer to said third station.

2. Plant for manufacturing conglomerate slabs of stone material according to claim 1, characterized in that said transfer means comprise means (40, 41) for gripping the moulds (22).

3. Plant for manufacturing conglomerate slabs of stone material according to claim 2, characterized in that said means for gripping the moulds (22) are gripper jaws (40, 41).

4. Plant for manufacturing conglomerate slabs of stone material according to claim 1, characterized in that said transfer means comprise hook members able to extend and retract so as to engage with shaped projections formed on the outer walls of the moulds (22).

5. Plant for manufacturing conglomerate slabs of stone material according to claim 1, in which the vibrocompression machine of said second station comprises a base (30) underneath said vibrating ram or pressing plate (35), characterized in that it comprises a supporting and sliding surface (36), downstream of said second station, having its upper surface aligned horizontally with the upper surface of the base (30) of the vibrocompression press and able to receive the mould (22) extracted from the said vibrocompression machine.

6. Plant for manufacturing conglomerate slabs of stone material according to claim 5, characterized in that said transfer means comprise a carriage (38) with one or two gripper jaws for gripping the moulds (22), said carriage being movable between a position, where it is positioned on said supporting and sliding surface (36) and where it deposits the mould (22) extracted from the vibrocompression machine, and a position where gripper jaws (40) engage with the mould (22) to be introduced into the vibrocompression machine.

7. Plant for manufacturing conglomerates slabs of stone material according to claim 6, characterized in that said carriage (38) consists of a frame formed by two longitudinal members and two cross-pieces (46), said frame being mounted on wheels (42) co-operating with sliding guides or rails (44) which are provided on said supporting and sliding surface (36) and which extend above the base (30) of the vibrocompression machine.

8. Plant for manufacturing conglomerate slabs of stone material according to claim 6, characterized in that motor means (70) ensure the displacement of said carriage (38) between the two said positions.

9. Plant for manufacturing conglomerate slabs of stone material according to claim 3, characterized in that said gripper jaws (40, 41) are provided with raising devices (50, 52, 58, 60) and comprise a bracket (54) integral with the one (46) of said two cross-pieces facing said vibrocompression machine, said bracket (54) having a bottom horizontal side (56) movable between a position raised with respect to the surface of said supporting and sliding plane (36) and a gripping position lowered onto said plane (56), each bracket (54) having, integral therewith, a gripping member (62) movable between a position raised from the plane of said horizontal side (56), and a gripping position lowered towards the same horizontal side (56), each mould (22) having a projecting lip (68) able to be trapped between said gripping member (62) and said horizontal side (56).

10. Plant for manufacturing conglomerate slabs of stone material according to claim 7, characterized in that the cross-piece (46) of the two cross-pieces of said carriage (38) facing said vibrocompression machine is integral with a flange (48), the said flange being integral with the piston (52) of a first cylinder and piston assembly, so that the vertical displacement of said flange (48) between the two said positions is determined by the displacement of said piston (52) with respect to the cylinder (50) of said first assembly.

11. Plant for manufacturing conglomerate slabs of stone material according to claim 9, characterized in that said gripping member (62) is integral with the piston (60) of a second cylinder and piston assembly integral with said bottom side (56) of said flange (48), so that the said vertical displacement of said gripping member (62) between the said two positions is determined by the displacement of said piston (60) with respect to the cylinder (58) of said second assembly.

12. Plant for manufacturing conglomerate slabs of stone material according to claim 11, characterized in that said gripping member (62) is integral with a bush (64) sliding along a pin (66) integral with said bottom side (56) of said flange (48).
